(19) United States
(12) Patent Application Publication
(10) Pub. No.: US 2026/0045745 A1
(43) Pub. Date: Feb. 12, 2026

(54) ELECTRICAL CONNECTOR FOR AUTOMOTIVE APPLICATIONS

(71) Applicant: Aptiv Technologies AG, Schaffhausen (CH)

(72) Inventor: Gert DROESBEKE, Erkrath (DE)

(21) Appl. No.: 19/296,264

(22) Filed: Aug. 11, 2025

(30) Foreign Application Priority Data
Aug. 12, 2024 (EP) 24194128.5

(51) Int. Cl. H01R 13/6597; H01R 13/6473; H01R 13/6594

(52) U.S. Cl. CPC H01R 13/6597; H01R 13/6594; H01R 13/6473; H01R 2201/26

(57) ABSTRACT

An electrical connector for automotive applications includes a housing, at least one signal conductor and at least one ground conductor. The at least one signal conductor is arranged at least in part within the housing and has a first end projecting from the housing, being electrically insulated from the housing. The at least one ground conductor is arranged at least in part within the housing and has a first end projecting from the housing, being in electrical contact with the housing. The connector provides insulated signal paths and a grounding connection via the housing.

### CROSS-REFERENCE TO RELATED APPLICATION

This application claims the benefit of and priority to European Application No. 24194128.5 filed with the European Patent Office on Aug. 12, 2024, the contents of which are incorporated by reference herein.

### TECHNICAL FIELD

The present disclosure relates to an electrical connector for automotive applications.

### BACKGROUND

Electrical connectors are used in automotive applications to electrically connect different modules of a vehicle. Examples include actuators, sensors, and control modules. A connector usually includes one or more electrical terminals or conductors, a housing and related parts that terminate a cable for the purpose of providing a suitable electrical connection and disconnection. The electrical connection may support supply voltages but also data lines which are operated at high frequencies, e.g., up to 20 GHz. Therefore, an electrical connector for automotive applications needs a housing forming an electromagnetic shield to protect the electrical connection from the environment. Often, such housing also acts as signal ground for data applications.

It is important that the relative position between the terminals or conductors and the signal ground provided for example by the housing or another terminal/conductor remains stable even in case of vibrations or shocks as found in automotive applications, particularly in truck applications. This is as the distance has an influence on the impedance of the terminals or conductors which, however, should be as constant as possible to avoid an impedance mismatch which could lead to signal reflections. Similarly, if the terminals or conductors are realized as differential pairs, their relative distance needs to remain stable as well to realize a constant differential impedance. Again, a mismatch in differential impedance might lead to an impedance mismatch causing signal reflections.

### SUMMARY

The electrical connector for automotive applications according to the disclosure includes a housing. At least one signal conductor arranged at least in part in the housing and including a first end projecting from the housing. The at least one signal conductor is electrically insulated from the housing. At least one ground conductor arranged at least in part in the housing and includes a first end projecting from the housing. The at least one ground conductor is in electrical contact with the housing.

By having a ground conductor in the housing together with a signal conductor, the impedance or differential impedance in case of a differential pair can be maintained essentially constant even in case of strong vibrations or shocks. In addition, the first ends of the signal and ground conductors can function as solder pins such that the housing itself does not need to be soldered in order to attach the connector to a printed circuit board. Additional advantages of the present disclosure will be described further below.

The electrical connector according to the disclosure may include two signal conductors and two ground conductors each configured as defined above, wherein the signal conductors are arranged between the ground conductors. Such an arrangement leads to an optimum differential impedance matching and minimizes the cross talk between multiple coaxial and/or differential pair conductors.

The at least one signal conductor and the at least one ground conductor may be at least partially arranged in a support structure that mechanically connects the conductors to the housing and that is electrically insulating, wherein portions of the conductors protrude from the support structure. Thus, the support structure fixes the conductors inside the housing and minimizes movement of the conductors relative to the housing but also movement of the conductors relative to each other which is beneficial for a constant (differential) impedance.

The support structure may be overmolded around the at least one signal conductor and the at least one ground conductor. Overmolding is a rather cost effective process of forming the support structure with little tolerances as to dimensions and distance between the conductors.

The housing may be press-fitted onto the at least one ground conductor, preferably wherein the housing and/or the at least one ground conductor include a tin finishing, such that a cold weld is formed by the press-fitting connection. Thus, an electrical connection with low contact resistance can be made between the at least one ground conductor and the housing without additional process steps. For example, an additional hot weld or soldering step can be omitted.

The connector may include a front ground conductor and a rear ground conductor and a portion of the rear side of the housing may be press-fitted onto the rear ground conductor. This leads to an electrical connection between the rear ground conductor and the housing. In addition, as pressure is applied onto the rear ground conductor, the front ground conductor is pressed against a front portion of the housing if both are arranged in a support structure. In this way, also the front ground conductor may form a cold weld with the housing.

The housing may include at least one protrusion adapted to rest on a printed circuit board when the electrical connector is mounted on the printed circuit board. This is particularly advantageous during mounting the connector to a printed circuit board, e.g. by pressing the protruding first ends of the conductors into corresponding printed circuit board holes or vias, because a high pressure is exerted onto the printed circuit board during such process which is distributed by the protrusion and may avoid a cracking or breaking of the printed circuit board. In addition, the protrusion also stabilizes the connector in operation, in particular during vibrations or shocks.

The at least one signal conductor and/or the at least one ground conductor may be made from the same material as the housing. Thus, the housing and the conductors include the same thermal expansion coefficient which leads to a more stable relative alignment even under temperature variations. This again adds to a constant (differential) impedance.

The at least one signal conductor or and/or the at least one ground conductor and/or the housing may be stamped parts. Stamped features are more accurate than molded features. Hence, minimizing the role of a support structure (such as an over-mold) in the positioning of the conductors will reduce tolerances and result in a more stable and narrower (differential) impedance match.

The first end of the at least one ground conductor may project farther from the housing than the first end of the at least one signal conductor. In this way, the solder tails of the ground conductor can be used for pre-alignment when mounting the connector to a printed circuit board. Thus, tight PCB holes can be achieved around the thinner and shorter solder tail of the signal conductor. The smaller the hole or via in the printed circuit board for the signal leads, the better the (differential) impedance match of the signal lines.

The at least one signal conductor may include a smaller diameter than the at least one ground conductor. As explained above, small conductor diameters are beneficial for the (differential) impedance match which minimizes signal reflections.

A second end of the at least one signal conductor may be adapted to come into electrical contact with an electrical conductor of a complementary electrical connector. Thus, the second end of the signal conductor establishes the electrical contact to a corresponding conductor in a complementary connector.

A second end of the at least one ground conductor may protrude from the housing. This allows to position and align the connector in a casing including a plurality of connectors as described herein. Moreover, it allows an electrical link between the ground conductors (and optionally the housing) of one connector and another connector or multiple other connectors as described herein. For example, only a metal comb needs to be slotted over these protrusions, in which case the pitch between two such connectors will be very precise.

Another aspect of the present disclosure relates to a set including a plurality of electrical connectors as described herein. The set may further include a casing, wherein the plurality of electrical connectors is arranged in the casing, preferably wherein the electrical connectors are configured such that a second end of the at least one ground conductor protrudes from the housing and the second end of each ground conductor is received by a corresponding slot in the casing. The advantages described above and therein with respect to a connector according to the disclosure also applies to a set of such connectors.

### BRIEF DESCRIPTION OF THE DRAWINGS

Possible embodiments of the present invention are described in more detail in the following detailed description with reference to the following figures. These figures show:

FIGS. 1A and 1B are isometric drawings of an electrical connector for automotive applications according to several embodiments.

FIG. 2 is an isometric drawing of the inner parts of the connector of FIGS. 1A and 1B in more detail according to several embodiments.

FIG. 3 is a flow chart showing a method of manufacturing the connector of FIGS. 1A, 1B, and 2 according to several embodiments.

### DETAILED DESCRIPTION

In the following, preferred embodiments of the present disclosure are described in detail with respect to the figures.

For the sake of brevity, only a few embodiments will be described below. The person skilled in the art will recognize that the features described with reference to these specific embodiments may be modified and combined in different ways and that individual features may also be omitted. The general explanations in the sections above also apply to the more detailed explanations below.

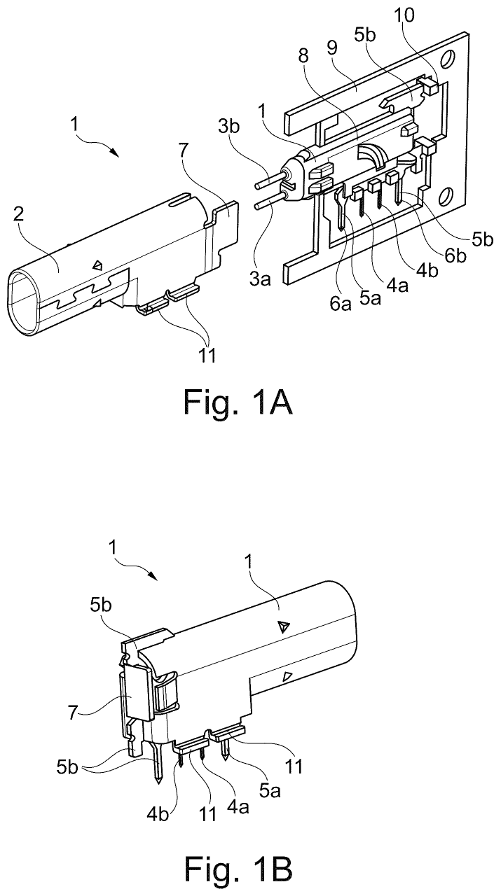

FIGS. 1A and 1B illustrates an embodiment of an electrical connector 1 for automotive applications according to the disclosure. The connector 1 in this example is a data connector which is used in an automotive application such as a car or truck. As such, the connector 1 is adapted to be mounted on a printed circuit board. The connector 1 includes a housing 2. The housing is made from a metal material to provide an electrical shielding to the connector 1. Examples of suitable metal materials include steel, copper, aluminum, and suitable alloys.

FIG. 1A also shows the inner parts of the connector 1. For reasons of illustrations and clarity, those parts are shown before being inserted into the housing 2, whereas FIG. 1B shows the finished connector 1, i.e., with the inner parts inserted into the housing. Those inner parts include two signal conductors 3a and 3b. In other embodiments, the number of signal conductors may be different. In the example of FIGS. 1A and 1B, the signal conductors 3a and 3b are designed as a differential pair, i.e., suitable for differential signal transmission and having a matched differential impedance to avoid signal reflections which would be detrimental to a reliable data transmission. In other examples, the conductors would form one or more coaxial transmission lines.

As illustrated in FIG. 1B, in which the inner parts are inserted into the housing 2, a first end 4a and 4b, respectively, of each of the signal conductors 3a and 3b projects from the housing 2. Those ends are adapted to be received in corresponding holes or vias of a printed circuit board. In this way, the first ends 4a and 4b of the signal conductors 3a and 3b can be soldered onto a printed circuit board. The signal conductors 3a and 3b, when arranged in the housing 2, are electrically insulated from the housing 2. The signal conductors 3a and 3b can for example be made from steel, copper, aluminum, and suitable alloys. For reasons of thermal and dimensional stability, they are made from the same material as the housing 2.

Second ends of the signal conductors 3a, 3b (which can be seen in FIG. 1A) are adapted to come into electrical contact with an electrical conductor of a complementary electrical connector. Thus, the second ends of the signal conductors 3a, 3b establish the electrical contact to a corresponding conductor in a complementary connector.

In the example of FIGS. 1A and 1B, the connector also includes two ground conductors 5a and 5b which are arranged near the signal conductors 4a and 4b. Again, in other embodiments, the number of ground conductors may be different. The ground conductors 5 and 5b include respective first and second ends 6a and 6b projecting from the housing 2. Just like the first ends 4a and 4b of the signal conductors 3a and 3b, the first ends 6a and 6b of the ground conductors 5a and 5b are adapted to be received in corresponding holes or vias of a printed circuit board. In this way, the first ends 6a and 6b of the signal conductors 5a and 5b can be soldered onto a printed circuit board. The ground conductors 5a and 5b can for example be made from steel, copper, aluminum, and suitable alloys. For reasons of thermal and dimensional stability, they are made from the same material as the housing 2 and/or the signal conductors 3a and 3b.

Unlike the signal conductors 3a and 3b, the ground conductors 5a and 5b are in electrical contact with the housing 2. For the rear ground conductor 5b, this is illustrated in FIG. 1B in which the flap 7 of the housing 2, unlike in FIG. 1A, is closed and firmly pressed against the ground conductor 5b. For example, the flap 7 may be press-fitted onto the ground conductor 5b. If the housing 2 and/or the ground conductor 5b include a tin finishing, a cold weld may be formed by the press-fitting.

In the example of FIGS. 1A and 1B, and as depicted in FIG. 1B, portions of the rear ground conductor 5b protrude from the housing 2. This allows to position and align the connector 1 in a casing including a plurality of connectors 1 as described herein. Moreover, it allows to electrically link the ground conductors 5a, 5b (and optionally the housing 2) of one connector with another connector or multiple other connectors as described herein. For example, only a metal comb needs to be slotted over the protruding portion of the rear ground connector 5b, in which case the pitch between two such connectors will be very precise.

In the example of FIGS. 1A and 1B, the signal conductors 3a, 3b have a smaller diameter as compared to the ground conductors 5a, 5b. Small conductor diameters are generally beneficial for the (differential) impedance match which minimizes signal reflections. In the exemplary embodiment of FIGS. 1A and 1B, the signal conductors 3a, 3b have a rectangular cross section with a dimension of 0.285 mm by 0.285 mm. The ground conductors 5a, 5b have a rectangular cross section with a dimension of 0.5 mm by 0.55 mm.

One particular feature of the connector 1 of the example of FIGS. 1A and 1B is that the first ends 6a, 6b of the ground conductors 5a, 5b project farther from the housing 2 than the first ends of the signal conductors 3a and 3b. In this way, the solder tails of the ground conductors 5a, 5b can be used for pre-alignment when mounting the connector 1 to a printed circuit board. Thus, tight PCB holes can be achieved around the thinner and shorter solder tails of the signal conductors 3a, 3b compared to the thicker ground conductors 5a, 5b.

In the example of FIGS. 1A and 1B, the connector 1 also includes a support structure 8 in which portions of the signal conductors 3a, 3b and of the ground conductors 5a, 5b are arranged. The support structure 8 mechanically connects the conductors 3a, 3b, 5a and 5b to the housing 2 is electrically insulating. Portions of the conductors 3a, 3b, 5a and 5b, e.g., its first ends 4a, 4b, 6a and 6b protrude from the support structure 8. Thus, the support structure fixes the conductors 3a, 3b, 5a and 5b inside the housing 2 and minimizes movement of the conductors 3a, 3b, 5a and 5b relative to the housing 2 but also movement of the conductors relative to each other. The support structure 8 in the example of FIGS. 1A and 1B is obtained by overmolding portions of the conductors 3a, 3b, 5a and 5b.

The support structure 8 also has the effect that if the flap 7 of the housing 2 is pressed against the rear ground connector 5b, as described above, the front ground connector 5a is pressed against a front side of the housing 2 such that an electrical connection between both is established. If the housing 2 and/or the front ground connector 5a include a tin finishing, a cold weld may form at sufficient pressure.

In the example of FIGS. 1A and 1B, the housing 2 includes protrusions 11 which are adapted to rest on a printed circuit board when the electrical connector 1 is mounted on the printed circuit board. This is particularly advantageous during mounting the connector 1 to a printed circuit board, e.g. by pressing the protruding first ends 4a, 4b, 6a and 6b of the conductors 3a, 3b, 5a and 5b into corresponding printed circuit board holes or vias, because a high pressure is exerted onto the printed circuit board during such process which is distributed by the protrusions 11 and may avoid a cracking or breaking of the printed circuit board. In addition, the protrusions 11 also stabilize the connector 1 in operation, in particular during vibrations or shocks.

It should be noted that in FIG. 1B additional parts, namely a mounting frame 9 and spacers 10, are shown which are auxiliary parts used in manufacturing the inner parts of the connector 1 and are removed before inserting the inner parts, i.e. signal conductors 3a, 3b, ground conductors 5a, 5b and support structure 8, into the housing 2.

The at least one signal conductor or and/or the at least one ground conductor and/or the housing may be stamped parts. Stamped features are more accurate than molded features. Hence, minimizing the role of a support structure (such as an over-mold) in the positioning of the conductors will reduce tolerances and result in a more stable and narrower (differential) impedance match.

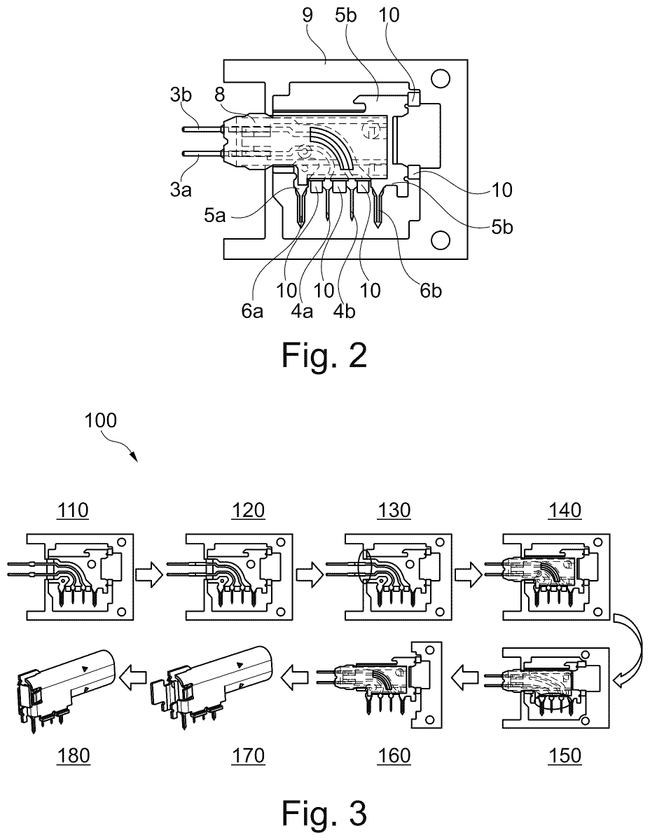

FIG. 2 illustrates the inner parts of the connector 1 of FIGS. 1A and 1B in more detail. For reasons of illustration, the support structure 8 is shown half-transparent so that the signal conductors 3a, 3b and ground conductors 5a, 5b embedded in the overmold support structure 8 can be seen. As depicted in FIG. 2, the shape of the ground connectors 5a, 5b closely follows the shape of the signal connectors 3a, 3b which is beneficial for the differential impedance match of the signal conductors 3a, 3b. Consequently, the rear ground conductor 5b fills a rather substantial portion of the inside of the housing 2 (depicted in FIGS. 1A and 1B).

Just like in FIG. 1B, additional parts are shown in FIG. 2, namely a mounting frame 9 and spacers 10 which are auxiliary parts used in manufacturing the inner parts of the connector 1 and are removed before inserting the inner parts, i.e. signal conductors 3a, 3b, ground conductors 5a, 5b and support structure 8, into the housing 2 (depicted in FIGS. 1A and 1B).

FIG. 3 illustrates a method 100 of manufacturing the connector 1 as described with reference to FIGS. 1A, 1B and 2. In a first step 110 the signal conductors 3a, 3b and ground conductors 5a, 5b are stamped out of a metal sheet such as steel, copper, aluminum, or a suitable alloy. This is done in a single stamping step such that the dimensions and mutual distances are well defined. Moreover, stamping allows to manufacture the conductors with minimal tolerances. To maintain the mutual positions between the conductors in subsequent steps, spacers 10 are arranged between the conductors and the conductors are arranged in a mounting frame 9.

In a step 120, the signal conductors 3a and 3b are twisted by 90°.

In a step 130, the spacers 10 at the front-side of the inner parts of the connector, i.e., between the ground conductor 5a, signal conductor 3a, signal conductor 3b and ground conductor 5b are removed to prepare for the subsequent overmolding step.

In a step 140, portions of the signal conductors 3a, 3b and ground conductors 5a, 5b are overmolded to form the support structure 8.

In a step 150, the spacers 10 at the bottom side of the inner parts of the connector, i.e., between the ground conductor 5a, signal conductor 3a, signal conductor 3b and ground conductor 5b are removed.

In a step 160, portions of the mounting frame 9 are removed to prepare for the subsequent press-fitting step.

In a step 170, the inner parts are press-fitted into the housing 2. The remaining portions of the mounting frame 9 and remaining spacers 10 are removed.

Finally, in a step 180, the flap 7 is bent and press-fitted against the rear ground conductor 5b.

### LIST OF REFERENCE SIGNS

1 connector
2 housing
3a, 3b signal conductors
4a, 4b first ends of signal conductors
5a, 5b ground conductors
6a, 6b first ends of ground conductors
7 flap
8 support structure
9 mounting frame
10 spacers
100 manufacturing method
110 stamping
120 twisting
130 removing spacers
140 overmolding
150 removing spacers
160 removing portions of mounting frame
170 press-fitting inner parts
180 press-fitting flap

1. An electrical connector for automotive applications, comprising:
a housing;
at least one signal conductor arranged at least in part in the housing and comprising a first end projecting from the housing, wherein the at least one signal conductor is electrically insulated from the housing; and
at least one ground conductor arranged at least in part in the housing and comprising a first end projecting from the housing, wherein the at least one ground conductor is in electrical contact with the housing.

2. The electrical connector according to claim 1, further comprising two of the at least one signal conductor, wherein the signal conductors are arranged between the ground conductors.

3. The electrical connector according to claim 1, wherein the at least one signal conductor and the at least one ground conductor are arranged at least partially in a support structure that mechanically connects the conductors to the housing and that is electrically insulative and wherein portions of the conductors protrude from the support structure.

4. The electrical connector according to claim 3, wherein the support structure is overmolded around the at least one signal conductor and the at least one ground conductor.

5. The electrical connector according to claim 1, wherein the housing is press-fitted onto the at least one ground conductor.

6. The electrical connector according to claim 5, wherein the housing and/or the at least one ground conductor comprise a tin finishing, such that a cold weld is formed by the press-fit connection.

7. The electrical connector according to claim 5, wherein the connector comprises a front ground conductor and a rear ground conductor and wherein a portion of a rear side of the housing is press-fit onto the rear ground conductor.

8. The electrical connector according to claim 1, wherein the housing comprises at least one protrusion adapted to rest on a printed circuit board when the electrical connector is mounted on the printed circuit board.

9. The electrical connector according to claim 1, wherein the at least one signal conductor is made from the same material as the housing.

10. The electrical connector according to claim 1, wherein the at least one ground conductor is made from the same material as the housing.

11. The electrical connector according to claim 1, wherein the at least one signal conductor or and/or the at least one ground conductor and/or the housing are stamped parts.

12. The electrical connector according to claim 1, wherein the first end of the at least one ground conductor projects farther from the housing than the first end of the at least one signal conductor.

13. The electrical connector according to claim 1, wherein the at least one signal conductor comprises a smaller diameter than the at least one ground conductor.

14. The electrical connector according to claim 1, wherein a second end of the at least one signal conductor is adapted to come into electrical contact with an electrical conductor of a complementary electrical connector.

15. The electrical connector according to claim 1, wherein a second end of the at least one ground conductor protrudes from the housing.

16. A set comprising a plurality of electrical connectors according to claim 1.

17. The set according to claim 16, further comprising a casing, wherein the plurality of electrical connectors is arranged in the casing.

18. The set according to claim 17, further comprising a casing, wherein a second end of the at least one ground conductor protrudes from the housing and wherein the second end of each ground conductor is received by a corresponding slot in the casing.
